(19) United States
(12) Patent Application Publication
(10) Pub. No.: US 2019/0211195 A1
(43) Pub. Date: Jul. 11, 2019

(54) Aromatic Vinyl-Based Copolymer, Method for Preparing Same, and Thermoplastic Resin Composition Including Same

(71) Applicant: LOTTE ADVANCED MATERIALS CO., LTD., Yeosu-si (KR)

(72) Inventors: Joo Hyun JANG, Uiwang-si (KR); Kwang Soo PARK, Uiwang-si (KR); Kyung Min PARK, Uiwang-si (KR); Ki Bo CHANG, Uiwang-si (KR); Yu Jin JUNG, Uiwang-si (KR)

(21) Appl. No.: 16/328,781

(22) PCT Filed: Aug. 2, 2017
(86) PCT No.: PCT/KR2017/008320

§ 371 Date: Feb. 27, 2019

(30) Foreign Application Priority Data
Aug. 29, 2016 (KR) 10-2016-0110368

(51) Int. Cl. C08L 25/12; C08F 212/10

(52) U.S. Cl. CPC C08L 25/12; C08F 212/10; C08L 2205/03; C08L 2205/025; C08F 2800/20

(57) ABSTRACT

An aromatic vinyl-based copolymer of the present invention is a copolymer obtained in a batch polymerization reaction of aromatic vinyl monomers and cyanovinyl monomers, and is characterized by having a weight average molecular weight of about 120,000 to about 400,000 g/mol, and a yellowness index (YI) of at most about 20, as measured according to ASTM D1925 using a 3.2 mm thick specimen. The aromatic vinyl-based copolymer and a thermoplastic resin composition including the same have excellent heat resistance, color, flowability, and impact resistance and the like.

### TECHNICAL FIELD

The present invention relates to an aromatic vinyl-based copolymer, a method of preparing the same, and a thermoplastic resin composition including the same. More particularly, the present invention relates to an aromatic vinyl-based copolymer prepared through batch type polymerization to have good properties in terms of thermal resistance, color and flowability, a method of preparing the same, and a thermoplastic resin composition including the same.

### BACKGROUND ART

Thermoplastic resins have a lower density than glass or metal and exhibit good properties in terms of moldability, impact resistance, and the like. With recent trend of low cost, large size and light weight of molded products, plastic products using thermoplastic resins are rapidly replacing typical glass or metal in the art.

Among such thermoplastic resins, a rubber-modified vinyl copolymer resin such as ABS resin is a representative thermoplastic resin capable of realizing good impact resistance and stiffness. In addition, the rubber-modified vinyl-based copolymer resin has good thermal resistance and thus is broadly used as an automotive interior material requiring high thermal resistance and impact resistance.

In general, for improvement in thermal resistance of the rubber-modified vinyl copolymer resin, a predetermined amount or more of monomers having high thermal resistance (α-methylstyrene (AMS), N-phenyl maleimide (PMI), and the like) is added to a matrix resin (an aromatic vinyl copolymer, such as SAN) and/or an impact modifier (a rubber-modified vinyl graft copolymer, such as g-ABS). However, the presence of the highly thermal resistant monomers can cause deterioration in compatibility with the matrix resin and the impact modifier and degradation in appearance and impact resistance due to agglomeration of the impact modifier.

Thermal resistance of the aromatic vinyl-based copolymer may be improved by increasing the amount of vinyl cyanide monomers therein or by increasing the molecular weight thereof, instead of using the highly thermal resistant monomers. However, the yellow index (YI) of the aromatic vinyl-based copolymer increases with increasing amount of the vinyl cyanide monomers, thereby making it difficult to realize target colors, and an excessive increase in molecular weight can cause deterioration in flowability.

Therefore, there is a need for development of an aromatic vinyl-based copolymer that can secure good properties in terms of thermal resistance, color and flowability without using a highly thermal resistant monomer.

The background technique of the present invention is disclosed in Korean Patent Laid-open Publication No. 1993-0021665 and the like.

### DISCLOSURE

### Technical Problem

It is an object of the present invention to provide an aromatic vinyl-based copolymer prepared through batch type polymerization to have good properties in terms of thermal resistance, color and flowability, a method of preparing the same, and a thermoplastic resin composition including the same.

The above and other objects of the present invention can be achieved by the present invention described below.

### Technical Solution

One aspect of the present invention relates to an aromatic vinyl-based copolymer. The aromatic vinyl-based copolymer is prepared through batch polymerization of an aromatic vinyl monomer and a vinyl cyanide monomer and has a weight average molecular weight of about 120,000 g/mol to about 400,000 g/mol and a yellow index (YI) of about 20 or less, as measured on a 3.2 mm thick specimen in accordance with ASTM D1925.

In some embodiments, the aromatic vinyl monomer may include at least one of styrene, vinyl naphthalene, and p-methyl styrene.

In some embodiments, the vinyl cyanide monomer may include at least one of acrylonitrile, methacrylonitrile, and ethacrylonitrile.

In some embodiments, the aromatic vinyl-based copolymer may include about 50% by weight (wt %) to about 80 wt % of the aromatic vinyl monomer and about 20 wt % to about 50 wt % of the vinyl cyanide monomer.

In some embodiments, the aromatic vinyl-based copolymer may have a glass transition temperature difference (ΔTg) of about 1.5° C. or more, as calculated by Equation 1:

Glass transition temperature difference (ΔTg)=Tg (analyz.)−Tg (calcd.), [Equation 1]

wherein Tg (analyz.) is a glass transition temperature of the aromatic vinyl-based copolymer, as measured using a differential scanning calorimeter (DSC) at 20° C. to 160° C., and Tg (calcd.) is a glass transition temperature of the aromatic vinyl-based copolymer calculated by Equation 2:

$$\frac{1}{Tg ( calcd . )} = \frac{{w}_{1} {P}_{11}}{{Tg}_{11}} + \frac{{w}_{2} {P}_{22}}{{Tg}_{22}} + \frac{{w}_{1} {P}_{12} + {w}_{2} {P}_{21}}{{Tg}_{12}} \qquad [ Equation 2 ]$$

wherein w₁ and w₂ are weight fractions of unit monomers present in a polymer chain; each of P₁₁, P₁₂, P₂₁ and P₂₂ indicates a probability of various connections being present between the monomers, as calculated based on a weight ratio and a reactivity ratio of the monomers in polymerization; Tg₁₁ and Tg₂₂ are glass transition temperatures of homopolymers of the monomers, respectively; and Tg₁₂ is a glass transition temperature of the copolymer having an alternating sequence.

In some embodiments, the aromatic vinyl-based copolymer may have a Vicat softening temperature of about 106.5° C. or more, as measured in accordance with ASTM D1525 under a load of 5 kg at 50° C./hr.

Another aspect of the present invention relates to a method of preparing the aromatic vinyl-based copolymer. The preparation method includes: placing about 50 wt % to about 98 wt % of an aromatic vinyl monomer and a vinyl cyanide monomer based on 100 wt % of the aromatic vinyl monomer in a batch type reactor, followed by polymerizing the monomers until a conversion ratio reaches about 30% to about 90%; and continuously adding about 2 wt % to about 50 wt % of the aromatic vinyl monomer to the batch type reactor through a feeding pump, followed by polymerizing the monomers.

In some embodiments, the aromatic vinyl-based copolymer may have a weight average molecular weight of about 120,000 g/mol to about 400,000 g/mol and a yellow index (YI) of about 20 or less, as measured on a 3.2 mm thick specimen in accordance with ASTM D1925.

A further aspect of the present invention relates to a thermoplastic resin composition. The thermoplastic resin composition includes a matrix including a rubber-modified vinyl graft copolymer; and the aromatic vinyl-based copolymer.

In some embodiments, the rubber-modified vinyl graft copolymer may be prepared through graft polymerization of an aromatic vinyl monomer and a monomer copolymerizable with the aromatic vinyl monomer to a rubber polymer.

In some embodiments, the thermoplastic resin composition may include about 10 wt % to about 40 wt % of the rubber-modified vinyl graft copolymer and about 60 wt % to about 90 wt % of the matrix resin.

In some embodiments, the thermoplastic resin composition may have a yellow index (YI) of about 20 to about 26, as measured on a 3.2 mm thick specimen in accordance with ASTM D1925, a notched Izod impact strength of about 20 to about 25 kgf·cm/cm, as measured on a ⅛″ thick specimen in accordance with ASTM D256, and a Vicat softening temperature of about 105° C. or more, as measured in accordance with ASTM D1525 under a load of 5 kg at 50° C./hr.

### Advantageous Effects

The present invention provides an aromatic vinyl-based copolymer prepared through batch type polymerization to have good properties in terms of thermal resistance, color and flowability, a method of preparing the same, and a thermoplastic resin composition including the same.

### BEST MODE

Hereinafter, embodiments of the present invention will be described in detail.

An aromatic vinyl-based copolymer according to the present invention is prepared through batch type polymerization of an aromatic vinyl monomer and a vinyl cyanide monomer with addition polymerization of the aromatic vinyl monomer, and has a weight average molecular weight within the range of weight average molecular weight of an aromatic vinyl-based copolymer prepared through typical batch-type polymerization while having a decreased yellow index (YI) and improved thermal resistance.

In some embodiments, the aromatic vinyl-based copolymer may have a weight average molecular weight of about 120,000 g/mol to about 400,000 g/mol, for example, about 130,000 g/mol to about 180,000 g/mol, as measured by gel permeation chromatography (GPC), and a yellow index (YI) of about 20 or less, for example, about 10 to about 15, as measured on a 3.2 mm thick specimen in accordance with ASTM D1925. If the weight average molecular weight of the aromatic vinyl-based copolymer is less than about 120,000 g/mol, the aromatic vinyl-based copolymer can suffer from deterioration in mechanical properties, and if the weight average molecular weight of the aromatic vinyl-based copolymer exceeds about 200,000 g/mol, the aromatic vinyl-based copolymer can suffer from deterioration in flowability (processability) and the like. In addition, if the yellow index of the aromatic vinyl-based copolymer exceeds about 20, the aromatic vinyl-based copolymer can suffer from deterioration in color.

In some embodiments, the aromatic vinyl monomer may include styrene, vinyl naphthalene, p-methylstyrene, and combinations thereof excluding highly thermal resistant monomers (α-methylstyrene and the like). The aromatic vinyl monomer may be present in an amount of about 50 wt % to about 80 wt %, for example, about 55 wt % to about 75 wt %, based on 100 wt % of the aromatic vinyl monomer and the vinyl cyanide monomer. Within this range, the aromatic vinyl-based copolymer can have good processability and transparency.

In some embodiments, the vinyl cyanide monomer may include acrylonitrile, methacrylonitrile, ethacrylonitrile, and combinations thereof. The vinyl cyanide monomer may be present in an amount of about 20 wt % to about 50 wt %, for example, about 25 wt % to about 45 wt %, based on 100 wt % of the aromatic vinyl monomer and the vinyl cyanide monomer. Within this range, the aromatic vinyl-based copolymer can have good physical properties including impact strength, and good chemical resistance.

In some embodiments, the aromatic vinyl-based copolymer may be prepared by placing about 50 wt % to about 98 wt %, for example, about 60 wt % to about 95 wt %, of the aromatic vinyl monomer and the vinyl cyanide monomer based on 100 wt % of the aromatic vinyl monomer in a batch type reactor, polymerizing the monomers until a conversion ratio reaches about 30% to about 90%, for example, about 40% to about 80%, and continuously adding about 2 wt % to about 50 wt %, for example, about 5 wt % to about 40 wt %, of the aromatic vinyl monomer to the batch type reactor through a feeding pump, followed by polymerizing the monomers.

In some embodiments, polymerization may be performed by any typical polymerization method known in the art, such as emulsion polymerization, solution polymerization, suspension polymerization, bulk polymerization, and the like. For example, polymerization may be performed by suspension polymerization. Specifically, some of the aromatic vinyl monomer, the vinyl cyanide monomer, and, as needed, an aqueous system containing a typical dispersant, may be simultaneously added to the batch type reactor, followed by polymerization at about 70° C. to about 80° C. Then, when the conversion ratio is within a certain range, the remaining aromatic vinyl monomer may be further added through the feeding pump and polymerized.

In some embodiments, if the amount of the aromatic vinyl monomer continuously added through the feeding pump is less than about 2 wt % based on 100 wt % of the aromatic vinyl monomer, the aromatic vinyl-based copolymer can have an insignificant effect on reduction of the yellow index or can fail to improve thermal resistance, and if the amount of the aromatic vinyl monomer added therethrough exceeds about 50 wt %, there can be a problem of deterioration in suspension stability during polymerization.

In addition, when the aromatic vinyl monomer is continuously added at a conversion rate of less than about 30%, there can be a problem of deterioration in suspension stability upon polymerization, and when the aromatic vinyl monomer is continuously added at a conversion rate of greater than about 90%, there can be a problem of increase in amount of unreacted monomer. Here, the conversion rate can be obtained based on the weight of solid remainder after a sample of a reaction solution is dried at 100° C. for 1 hour.

In some embodiments, the aromatic vinyl-based copolymer may have a glass transition temperature difference (ΔTg) of about 1.5° C. or more, for example, about 2° C. or more, as calculated by Equation 1, meaning that an actual glass transition temperature of the aromatic vinyl-based copolymer according to the present invention increases above a theoretical glass transition temperature of an aromatic vinyl-based copolymer prepared using the same amounts of the same monomers as the aromatic vinyl-based copolymer according to the embodiments of the invention. Such increase in glass transition temperature may be caused by increase in probability of an alternating sequence in the copolymer through continuous addition upon copolymerization.

Glass transition temperature difference (ΔTg)=Tg (analyz.)−Tg (calcd.) [Equation 1]

wherein Tg (analyz.) is a glass transition temperature of the aromatic vinyl-based copolymer, as measured using a DSC at 20° C. to 160° C., and Tg (calcd.) is a glass transition temperature of the aromatic vinyl-based copolymer calculated by Equation 2:

$$\frac{1}{Tg ( calcd . )} = \frac{{w}_{1} {P}_{11}}{{Tg}_{11}} + \frac{{w}_{2} {P}_{22}}{{Tg}_{22}} + \frac{{w}_{1} {P}_{12} + {w}_{2} {P}_{21}}{{Tg}_{12}} \qquad [ Equation 2 ]$$

wherein w₁ and w₂ are weight fractions of unit monomers present in a polymer chain; each of P₁₁, P₁₂, P₂₁ and P₂₂ indicates a probability of various connections being present between the monomers, as calculated based on a weight ratio and a reactivity ratio of the monomers in polymerization; Tg₁₁ and Tg₂₂ are glass transition temperatures of homopolymers of the monomers, respectively; and Tg₁₂ is a glass transition temperature of the copolymer having an alternating sequence.

In some embodiments, the aromatic vinyl-based copolymer may have a Vicat softening temperature of about 106.5° C. or more, for example, about 107° C. to about 120° C., as measured in accordance with ASTM D1525 under a load of 5 kg at 50° C./hr, thereby securing good thermal resistance.

A thermoplastic resin composition according to the present invention includes: (A) a rubber-modified vinyl graft copolymer; and (B) a matrix resin including (B1) the aromatic vinyl-based copolymer.

(A) Rubber-Modified Vinyl Graft Copolymer

According to one embodiment of the invention, the rubber-modified vinyl graft copolymer may be a rubber-modified vinyl graft copolymer used for a typical thermoplastic resin composition. For example, the rubber-modified vinyl graft copolymer may be prepared by graft polymerization of a monomer mixture including an aromatic vinyl monomer and a monomer copolymerizable with the aromatic vinyl monomer to a rubber polymer. Specifically, the rubber-modified vinyl graft copolymer may be obtained by adding the aromatic vinyl monomer and the monomer copolymerizable with the aromatic vinyl monomer to the rubber polymer, followed by polymerization (graft copolymerization). Here, the polymerization may be performed by any typical polymerization method known in the art, such as emulsion polymerization, suspension polymerization, bulk polymerization, and the like.

In some embodiments, the rubber polymer may include, for example, diene rubbers such as polybutadiene, poly(styrene-butadiene), and poly(acrylonitrile-butadiene); saturated rubbers obtained by adding hydrogen to the diene rubbers, isoprene rubbers, acrylic rubbers such as poly(butyl acrylate), and ethylene-propylene-diene monomer terpolymer (EPDM), without being limited thereto. For example, the rubber polymer may be a diene rubber, specifically a polybutadiene rubber. The rubber polymer (rubber particles) may have an average particle diameter (Z-average) of about 0.05 μm to about 6 μm, for example, about 0.15 μm to about 4 μm, specifically about 0.25 μm to about 3.5 μm. Here, the average particle diameter (Z-average) was measured by a drying method known in the art using a Mastersizer 2000E series (Malvern). Within this range, the thermoplastic resin composition can have good properties in terms of impact resistance and appearance. The rubber polymer may be present in an amount of about 5 wt % to about 65 wt %, for example, about 10 wt % to about 60 wt %, specifically about 20 wt % to about 50 wt %, based on 100 wt % of the rubber-modified vinyl graft copolymer. Within this range, the thermoplastic resin composition can have good impact resistance and stiffness.

In some embodiments, the aromatic vinyl monomer is graft-copolymerizable with the rubber copolymer and may include, for example, styrene, α-methyl styrene, β-methyl styrene, p-methyl styrene, p-t-butyl styrene, ethyl styrene, vinylxylene, monochlorostyrene, dichlorostyrene, dibromostyrene, and vinyl naphthalene, and combinations thereof, without being limited thereto. For example, styrene may be used as the aromatic vinyl monomer. The aromatic vinyl monomer may be present in an amount of about 15 wt % to about 94 wt %, for example, about 20 wt % to about 80 wt %, specifically about 30 wt % to about 60 wt %, based on 100 wt % of the rubber-modified vinyl graft copolymer. Within this range, the thermoplastic resin composition can have good impact resistance and stiffness.

In some embodiments, the monomer copolymerizable with the aromatic vinyl monomer may include, for example, vinyl cyanide monomers, such as acrylonitrile, methacrylonitrile, ethacrylonitrile, and the like; and monomers for imparting processability and thermal resistance, such as acrylic acid, methacrylic acid, maleic anhydride, N-substituted maleimide, and the like, without being limited thereto. These may be used alone or as a mixture thereof. The monomer copolymerizable with the aromatic vinyl monomer may be present in an amount of about 1 wt % to about 50 wt %, for example, about 5 wt % to about 45 wt %, specifically about 10 wt % to about 30 wt %, based on 100 wt % of the rubber-modified vinyl graft copolymer. Within this range, the thermoplastic resin composition can exhibit good properties in terms of impact resistance, thermal resistance, processability, and the like.

In some embodiments, the rubber-modified vinyl graft copolymer may include, for example, methyl acrylonitrile-butadiene-styrene graft copolymer (g-ABS), acrylonitrile-ethylene propylene-styrene graft copolymer (g-AES), and acrylonitrile-styrene-acrylonitrile graft copolymer (g-ASA), without being limited thereto.

In some embodiments, the rubber-modified vinyl graft copolymer (A) may be present in an amount of about 10 wt % to about 40 wt %, for example, about 15 wt % to about 40 wt %, based on 100 wt % of the rubber-modified vinyl graft copolymer (A) and the matrix resin (B). Within this range, the thermoplastic resin composition can exhibit good properties in terms of impact resistance, color, thermal resistance, and property balance therebetween.

(B) Matrix Resin

According to one embodiment of the invention, the matrix resin includes the aromatic vinyl-based copolymer (B1), which exhibits good properties in terms of thermal resistance, color and flowability without using highly thermal resistant monomers and has good compatibility with the rubber-modified vinyl graft copolymer (A), thereby improving thermal resistance, color and flowability of the thermoplastic resin composition.

In some embodiments, the matrix resin (B) includes the aromatic vinyl-based copolymer (B1) in an amount of about 20 wt % or more, for example, about 30 wt % to about 100 wt %, based on 100 wt % of the matrix resin. Within this range, the thermoplastic resin composition can have good properties in terms of impact resistance, thermal resistance, color, processability, and the like.

In some embodiments, the matrix resin (B) may further include about 80 wt % or less, for example, about 70 wt % or less, of a second aromatic vinyl-based copolymer (B2) prepared by a typical polymerization method, in addition to the aromatic vinyl-based copolymer (B1). Within this range, the thermoplastic resin composition can have good properties in terms of impact resistance, thermal resistance, color, processability, and the like.

In some embodiments, the second aromatic vinyl-based copolymer (B2) may be an aromatic vinyl copolymer used in a typical thermoplastic resin composition. For example, the second aromatic vinyl-based copolymer (B2) may be prepared by mixing the aromatic vinyl monomer with the monomer copolymerizable with the aromatic vinyl monomer, followed by polymerization. Here, polymerization may be performed by any typical polymerization method in the art, such as emulsion polymerization, suspension polymerization, bulk polymerization, and the like.

In some embodiments, the aromatic vinyl monomer may include, for example, styrene, α-methylstyrene, β-methyl styrene, p-methylstyrene, p-t-butylstyrene, ethyl styrene, vinylxylene, monochlorostyrene, dichlorostyrene, dibromostyrene, vinyl naphthalene, and combinations thereof, without being limited thereto. For example, styrene may be used as the aromatic vinyl monomer. The aromatic vinyl monomer may be present in an amount of about 20 wt % to about 90 wt %, for example, about 30 wt % to about 80 wt %, based on 100 wt % of the second aromatic vinyl copolymer. Within this range, the thermoplastic resin composition can exhibit good properties in terms of impact resistance, stiffness, moldability, and the like.

In some embodiments, the monomer copolymerizable with the aromatic vinyl monomer may include, for example, vinyl cyanide monomers, such as acrylonitrile, methacrylonitrile, ethacrylonitrile, and the like; and monomers for imparting processability and thermal resistance, such as acrylic acid, methacrylic acid, maleic anhydride, N-substituted maleimide, and the like, without being limited thereto. These may be used alone or as a mixture thereof. The monomer copolymerizable with the aromatic vinyl monomer may be present in an amount of about 10 wt % to about 80 wt %, for example, about 20 wt % to about 70 wt %, based on 100 wt % of the second aromatic vinyl copolymer. Within this range, the thermoplastic resin composition can exhibit good properties in terms of impact resistance, stiffness, moldability, and the like.

In some embodiments, the second aromatic vinyl-based copolymer (B2) may have a weight average molecular weight (Mw) of about 10,000 g/mol to about 300,000 g/mol, for example, about 15,000 g/mol to about 200,000 g/mol, as measured by gel permeation chromatography (GPC). Within this range, the thermoplastic resin composition can have good properties in terms of impact resistance, stiffness, moldability, and the like.

In some embodiments, the matrix resin (B) may be present in an amount of about 60 wt % to about 90 wt %, for example, about 60 wt % to about 85 wt %, based on 100 wt % of the rubber-modified vinyl graft copolymer (A) and the matrix resin (B). Within this range, the thermoplastic resin composition can have good properties in terms of impact resistance, color, thermal resistance, and property balance therebetween.

In some embodiments, the thermoplastic resin composition may further include other thermoplastic resins in addition to the matrix resin so long as addition of the other thermoplastic resins does not deteriorate the advantageous effects of the present invention. For example, the other thermoplastic resins may include polycarbonate, polyethylene terephthalate, polybutylene terephthalate, and polyester, without being limited thereto. When such other resins are used, the other thermoplastic resins may be present in an amount of about 50 parts by weight or less, for example, about 1 to about 15 parts by weight, relative to 100 parts by weight of the rubber-modified vinyl graft copolymer (A) and the matrix resin (B), without being limited thereto.

In addition, the thermoplastic resin composition may further include any typical additives used in resin compositions. Examples of the additives may include fillers, reinforcing agents, stabilizers, colorants, antioxidants, antistatic agents, flow enhancers, release agents, nucleating agents, and combinations thereof, without being limited thereto. The additives may be present in an amount of about 25 parts by weight or less, for example, about 10 parts by weight or less, relative to 100 parts by weight of the rubber-modified vinyl graft copolymer (A) and the matrix resin (B), without being limited thereto.

In some embodiments, the thermoplastic resin composition may be prepared by any known method for preparing a thermoplastic resin composition. For example, the polycarbonate resin composition may be prepared in pellet form by mixing the above components and optionally other additives by a typical method, followed by melt extrusion using a twin screw extruder or the like. The prepared pellets may be formed into various molded products through various molding methods, such as injection molding, extrusion molding, vacuum molding, cast molding, and the like.

In some embodiments, the thermoplastic resin composition may have a yellow index (YI) of about 20 to about 26, for example, about 21 to about 25.5, as measured on a 3.2 mm thick specimen in accordance with ASTM D1925, a notched Izod impact strength of about 20 to about 25 kgf·cm/cm, for example, about 21 to about 24 kgf·cm/cm, as measured on a ⅛″ thick specimen in accordance with ASTM D256, and a Vicat softening temperature of about 105° C. or more, for example, about 105° C. to about 120° C., as measured in accordance with ASTM D1525 under a load of 5 kg at 50° C./hr.

### MODE FOR INVENTION

Next, the present invention will be described in more detail with reference to some examples. It should be understood that these examples are provided for illustration only and are not to be in any way construed as limiting the present invention.

Description of details apparent to those skilled in the art will be omitted for clarity.

### EXAMPLE

### Example 1: Preparation of Aromatic Vinyl-Based Copolymer

In a batch type reactor, 59 wt % of styrene among the total of 64 wt % styrene, 36 wt % of acrylonitrile, and 0.5 parts by weight of a dispersant (tricalcium phosphate) and 140 parts by weight of water relative to 100 parts by weight of the styrene and the acrylonitrile were collectively placed and reacted until the conversion rate reached 80% at 75° C., and then the remaining 5 wt % styrene was continuously added to the batch type reactor (input rate: 30 g/min) through a feeding pump, thereby preparing an aromatic vinyl-based copolymer (yield: 98%, weight average molecular weight: 131,000 g/mol). The glass transition temperature, glass transition temperature difference, Vicat softening temperature and yellow index of the prepared aromatic vinyl-based copolymer were measured by the following evaluation method, and measurement results are shown in Table 1.

### Example 2: Preparation of Aromatic Vinyl-Based Copolymer

In a batch type reactor, 60 wt % of styrene among the total of 71 wt % styrene, 29 wt % of acrylonitrile, and 0.5 parts by weight of a dispersant (tricalcium phosphate) and 140 parts by weight of water relative to 100 parts by weight of the styrene and the acrylonitrile were collectively placed and reacted until the conversion rate reached 80% at 75° C., and then the remaining 11 wt % styrene was continuously added to the batch type reactor (input rate: 30 g/min) through a feeding pump, thereby preparing an aromatic vinyl-based copolymer (yield: 98%, weight average molecular weight: 181,000 g/mol). The glass transition temperature, glass transition temperature difference, Vicat softening temperature and yellow index of the prepared aromatic vinyl-based copolymer were measured by the following evaluation method, and measurement results are shown in Table 1.

### Comparative Example 1: Preparation of Aromatic Vinyl-Based Copolymer

In a batch type reactor, 64 wt % of styrene, 36 wt % of acrylonitrile, and 0.5 parts by weight of a dispersant (tricalcium phosphate) and 140 parts by weight of water relative to 100 parts by weight of the styrene and the acrylonitrile were collectively placed and reacted at 75° C., thereby preparing an aromatic vinyl-based copolymer (yield: 98%, weight average molecular weight: 131,000 g/mol). The glass transition temperature, glass transition temperature difference, Vicat softening temperature and yellow index of the prepared aromatic vinyl-based copolymer were measured by the following evaluation method, and measurement results are shown in Table 1.

### Comparative Example 2: Preparation of Aromatic Vinyl-Based Copolymer

In a batch type reactor, 71 wt % of styrene, 29 wt % of acrylonitrile, and 0.5 parts by weight of a dispersant (tricalcium phosphate) and 140 parts by weight of water relative to 100 parts by weight of the styrene and the acrylonitrile were collectively placed and reacted at 75° C., thereby preparing an aromatic vinyl-based copolymer (yield: 98%, weight average molecular weight: 181,000 g/mol). The glass transition temperature, glass transition temperature difference, Vicat softening temperature and yellow index of the prepared aromatic vinyl-based copolymer were measured by the following evaluation method, and measurement results are shown in Table 1.

### Comparative Example 3: Preparation of Aromatic Vinyl-Based Copolymer

In a batch type reactor, 54 wt % of α-methylstyrene, 17 wt % of styrene, 29 wt % of acrylonitrile, 0.5 parts by weight of a dispersant (tricalcium phosphate) and 140 parts by weight of water relative to 100 parts by weight of the α-methylstyrene, the styrene and the acrylonitrile were collectively placed and reacted at 95° C., thereby preparing an aromatic vinyl-based copolymer (yield: 97%, weight average molecular weight: 160,000 g/mol). The glass transition temperature, glass transition temperature difference, Vicat softening temperature and yellow index of the prepared aromatic vinyl-based copolymer were measured by the following evaluation method, and measurement results are shown in Table 1.

Property Evaluation

(1) Glass transition temperature (Tg, unit: ° C.): Glass transition temperature of each aromatic vinyl-based copolymer was measured using a Q2910 DSC (Differential Scanning calorimeter) (TA Instrument Inc.) based on the transition temperature measured by drying 0.5 mg of a sample under vacuum at 80° C. for 4 hours (moisture: 3,000 ppm or less), heating the sample from 20° C. to 160° C. at 20° C./min under a nitrogen atmosphere, leaving the sample at 160° C. for 5 minutes, cooling the sample to 20° C. at 10° C./min, leaving the sample at 20° C. for 5 minutes, and heating the sample to 160° C. at 10° C./min (2^{nd} scan).

(2) Glass transition temperature difference (ΔTg): Glass transition temperature difference was calculated by Equation 1.

Glass transition temperature difference (ΔTg)=Tg (analyz.)−Tg (calcd.) [Equation 1]

wherein Tg (analyz.) is a glass transition temperature of the aromatic vinyl-based copolymer, as measured using a DSC at 20° C. to 160° C., and Tg (calcd.) is a glass transition temperature of the aromatic vinyl-based copolymer calculated by Equation 2;

$$\frac{1}{Tg ( calcd . )} = \frac{{w}_{1} {P}_{11}}{{Tg}_{11}} + \frac{{w}_{2} {P}_{22}}{{Tg}_{22}} + \frac{{w}_{1} {P}_{12} + {w}_{2} {P}_{21}}{{Tg}_{12}} \qquad [ Equation 2 ]$$

wherein w₁ and w₂ are weight fractions of unit monomers present in a polymer chain; each of P₁₁, P₁₂, P₂₁ and P₂₂ indicates a probability of various connections being present between the monomers, as calculated based on a weight ratio and a reactivity ratio of the monomers in polymerization; Tg₁₁ and Tg₂₂ are glass transition temperatures of homopolymers of the monomers, respectively; and Tg₁₂ is a glass transition temperature of the copolymer having an alternating sequence.

(3) Vicat softening temperature (VST, unit: ° C.): Vicat softening temperature was measured in accordance with ASTM D1525 under a load of 5 kg at 50° C./hr.

(4) Yellow index (YI): Yellow index was measured on a 3.2 mm thick specimen using a spectrophotometer (Konika Minolta Co., Ltd.) in accordance with ASTM D1925.

TABLE 1

| | | Example | | Comparative Example | | |
|---|---|---|---|---|---|---|
| | | 1 | 2 | 1 | 2 | 3 |
| Styrene (wt %) | | 59 | 60 | 64 | 71 | 17 |
| Added styrene (wt %) | | 5 | 11 | — | — | — |
| α-methylstyrene (wt %) | | — | — | — | — | 54 |
| Acrylonitrile (wt %) | | 36 | 29 | 36 | 29 | 29 |
| Weight average molecular | | 131,000 | 181,000 | 131,000 | 181,000 | 160,000 |
| weight (g/mol) | | | | | | |
| Glass transition | Analyz. | 111.7 | 110.3 | 110.2 | 109.1 | 116.2 |
| temperature | Calcd. | 109.2 | 108.3 | 109.2 | 108.3 | 119.6 |
| (Tg, ° C.) | | | | | | |

| | | | | | |
|---|---|---|---|---|---|
| Glass transition temperature | 2.5 | 2.0 | 1.0 | 0.8 | −3.4 |
| difference (ΔTg) | | | | | |
| Vicat softening | 108.0 | 107.0 | 106.9 | 106.3 | 114.3 |
| temperature(VST, ° C.) | | | | | |
| Yellow index (YI) | 14.7 | 10.4 | 34.8 | 21.5 | 22.4 |

From the results shown in Table 1, it could be seen that the aromatic vinyl-based copolymers (Examples 1 and 2) according to the present invention had higher thermal resistance (glass transition temperature and Vicat softening temperature) and better color and flowability than typical aromatic vinyl-based copolymers (Comparative Examples 1 and 2). In addition, it could be seen that the aromatic vinyl-based copolymers according to the present invention exhibited better color properties (yellow index) than a typical thermal resistance aromatic vinyl-based copolymer (Comparative Example 3).

The rubber-modified vinyl graft copolymers and the aromatic vinyl-based copolymers used in Examples and Comparative Examples are as follows.

(A) Rubber-Modified Vinyl Graft Copolymer

g-ABS prepared through graft polymerization of 42 wt % of styrene and acrylonitrile (weight ratio: 75/25) to 58 wt % of butadiene rubber particles (average particle diameter (D50): 300 nm).

(B) Aromatic Vinyl-Based Copolymer

(B1) Styrene-acrylonitrile copolymer (SAN) of Example 1 was used.

(B2) Styrene-acrylonitrile copolymer (SAN) of Example 2 was used.

(B3) Styrene-acrylonitrile copolymer (SAN) of Comparative Example 1 was used.

(B4) Styrene-acrylonitrile copolymer (SAN) of Comparative Example 2 was used.

(B5) α-methylstyrene-styrene-acrylonitrile copolymer of Comparative Example 3 was used.

(B6) An aromatic vinyl-based copolymer (SAN) (weight average molecular weight: 133,000 g/mol) prepared by collectively placing 69 wt % of styrene, 31 wt % of acrylonitrile, and 0.5 parts by weight of a dispersant (tricalcium phosphate) and 140 parts by weight of water relative to 100 parts by weight of the styrene and the acrylonitrile in a batch type reactor, followed by reaction at 75° C. was used.

### Examples 3 and 4 and Comparative Examples 4 to 6: Preparation of Thermoplastic Resin Composition

A rubber-modified vinyl graft copolymer (A), an aromatic vinyl-based copolymer (B), 0.1 parts by weight of an antioxidant (Irganox 1076, Ciba Chemical Co., Ltd.), and 0.3 parts by weight of a stabilizer (magnesium stearate) relative to 100 parts by weight of rubber-modified vinyl graft copolymer and the aromatic vinyl-based copolymer were weighed as listed in Table 2 and mixed, followed by extrusion molding using a twin-screw type extruder (L/D=29, Φ=45) at 250° C. and preparation of a thermoplastic resin composition in pellet form using a pelletizer. The thermoplastic resin composition prepared in pellet form was dried in an oven at 100° C. for 2 hours, followed by injection molding using an injection molding machine (SELEX TE 150, Woojin Selex Co., Ltd.) under conditions of a molding temperature of 250° C. and a mold temperature of 60° C., thereby preparing a specimen for property evaluation. The prepared specimen was evaluated as to the following properties, and evaluation results are shown in Table 2.

Property Evaluation

(1) Vicat softening temperature (VST, unit: ° C.): Vicat softening temperature was measured in accordance with ASTM D1525 under a load of 5 kg at 50° C./hr.

(2) Yellow index (YI): Yellow index was measured on a 3.2 mm thick specimen using a spectrophotometer (Konika Minolta Co., Ltd.) in accordance with ASTM D1925.

(3) Notched Izod impact strength (unit: kgf·cm/cm): Impact strength was measured on a ⅛″ thick notched Izod specimen in accordance with ASTM D256.

TABLE 2

| | | Example | | Comparative Example | | |
|---|---|---|---|---|---|---|
| | | 3 | 4 | 4 | 5 | 6 |
| (A) (wt %) | | 22 | 22 | 22 | 22 | 22 |
| (B) (wt %) | (B1) | 30 | — | — | — | — |
| | (B2) | — | 30 | — | — | — |
| | (B3) | — | — | 30 | — | — |
| | (B4) | — | — | — | 30 | — |
| | (B5) | — | — | — | — | 30 |
| | (B6) | 48 | 48 | 48 | 48 | 48 |

| | | | | | |
|---|---|---|---|---|---|
| Vicat softening | 106.0 | 105.1 | 105.3 | 104.5 | 104.9 |
| temperature(VST, ° C.) | | | | | |
| Yellow index (YI) | 25.5 | 21.0 | 70.9 | 26.5 | 26.3 |
| Notched Izod impact strength | 21.8 | 21.5 | 20.0 | 20.7 | 20.6 |
| (kgf · cm/cm) | | | | | |

From the results shown in Table 2, it could be seen that the thermoplastic resin compositions (Examples 3 and 4) including the aromatic vinyl-based copolymers (B1, B2) according to the present invention had good properties in terms of thermal resistance, color, impact resistance, and the like.

On the contrary, the thermoplastic resin compositions (Comparative Examples 4 and 5) comprising only typical aromatic vinyl-based copolymers (B3, B4, B6) exhibited significant deterioration in color properties (yellow index) and much poorer properties in terms of thermal resistance and impact resistance than the thermoplastic resin compositions of Examples, and the thermoplastic resin composition (Comparative Example 6) prepared using the aromatic vinyl-based copolymer (B5) including a highly thermal resistant monomer instead of the aromatic vinyl-based copolymer (B1, B2) according to the present invention had poorer properties in terms of thermal resistance, color, and impact resistance than the thermoplastic resin compositions of Examples.

It should be understood that various modifications, changes, alterations, and equivalent embodiments can be made by those skilled in the art without departing from the spirit and scope of the present invention.

1. An aromatic vinyl-based copolymer prepared through batch polymerization of an aromatic vinyl monomer and a vinyl cyanide monomer, the aromatic vinyl-based copolymer having a weight average molecular weight of about 120,000 g/mol to about 400,000 g/mol and a yellow index (YI) of about 20 or less, as measured on a 3.2 mm thick specimen in accordance with ASTM D1925.

2. The aromatic vinyl-based copolymer according to claim 1, wherein the aromatic vinyl monomer comprises styrene, vinyl naphthalene, and/or p-methyl styrene.

3. The aromatic vinyl-based copolymer according to claim 1, wherein the vinyl cyanide monomer comprises acrylonitrile, methacrylonitrile and/or ethacrylonitrile.

4. The aromatic vinyl-based copolymer according to claim 1, wherein the aromatic vinyl-based copolymer comprises about 50 wt % to about 80 wt % of the aromatic vinyl monomer and about 20 wt % to about 50 wt % of the vinyl cyanide monomer.

5. The aromatic vinyl-based copolymer according to claim 1, wherein the aromatic vinyl-based copolymer has a glass transition temperature difference (ΔTg) of about 1.5° C. or more, as calculated by Equation 1:
Glass transition temperature difference (ΔTg)=Tg (analyz.)−Tg (calcd.), [Equation 1]
wherein Tg (analyz.) is a glass transition temperature of the aromatic vinyl-based copolymer, as measured using a DSC at 20° C. to 160° C., and Tg (calcd.) is a glass transition temperature of the aromatic vinyl-based copolymer calculated by Equation 2:
$$\frac{1}{Tg ( calcd . )} = \frac{{w}_{1} {P}_{11}}{{Tg}_{11}} + \frac{{w}_{2} {P}_{22}}{{Tg}_{22}} + \frac{{w}_{1} {P}_{12} + {w}_{2} {P}_{21}}{{Tg}_{12}} \qquad [ Equation 2 ]$$
wherein w₁ and w₂ are weight fractions of unit monomers present in a polymer chain; each of P₁₁, P₁₂, P₂₁ and P₂₂ indicates a probability of various connections being present between the monomers, as calculated based on a weight ratio and a reactivity ratio of the monomers in polymerization; Tg₁₁ and Tg₂₂ are glass transition temperatures of homopolymers of the monomers, respectively; and Tg₁₂ is a glass transition temperature of the copolymer having an alternating sequence.

6. The aromatic vinyl-based copolymer according to claim 1, wherein the aromatic vinyl-based copolymer has a Vicat softening temperature of about 106.5° C. or more, as measured in accordance with ASTM D1525 under a load of 5 kg at 50° C./hr.

7. A method of preparing an aromatic vinyl-based copolymer, comprising:
placing about 50 wt % to about 98 wt % of an aromatic vinyl monomer based on 100 wt % of the aromatic vinyl monomer and a vinyl cyanide monomer in a batch type reactor, followed by polymerizing the monomers until a conversion ratio reaches about 30% to about 90%; and
continuously adding about 2 wt % to about 50 wt % of the aromatic vinyl monomer based on 100 wt % of the aromatic vinyl monomer to the batch type reactor through a feeding pump, followed by polymerizing the monomers.

8. The method of preparing an aromatic vinyl-based copolymer according to claim 7, wherein the aromatic vinyl-based copolymer has a weight average molecular weight of about 120,000 g/mol to about 400,000 g/mol and a yellow index (YI) of about 20 or less, as measured on a 3.2 mm thick specimen in accordance with ASTM D1925.

9. A thermoplastic resin composition comprising:
a rubber-modified vinyl graft copolymer; and
a matrix resin comprising the aromatic vinyl-based copolymer according to claim 1.

10. The thermoplastic resin composition according to claim 9, wherein the rubber-modified vinyl graft copolymer is prepared through graft polymerization of an aromatic vinyl monomer and a monomer copolymerizable with the aromatic vinyl monomer to a rubber polymer.

11. The thermoplastic resin composition according to claim 9, wherein the thermoplastic resin composition comprises about 10 wt % to about 40 wt % of the rubber-modified vinyl graft copolymer and about 60 wt % to about 90 wt % of the matrix resin.

12. The thermoplastic resin composition according to claim 9, wherein the thermoplastic resin composition has a yellow index (YI) of about 20 to about 26, as measured on a 3.2 mm thick specimen in accordance with ASTM D1925, a notched Izod impact strength of about 20 to about 25 kgf·cm/cm, as measured on a ⅛″ thick specimen in accordance with ASTM D256, and a Vicat softening temperature of about 105° C. or more, as measured in accordance with ASTM D1525 under a load of 5 kg at 50° C./hr.
